(19) United States
(12) Patent Application Publication
(10) Pub. No.: US 2018/0015370 A1
(43) Pub. Date: Jan. 18, 2018

(54) SYSTEM AND METHOD FOR RETAINING A STRATEGY VIDEO GAME PLAYER BY PREDICTING THE PLAYER GAME SATISFACTION USING PLAYER GAME BEHAVIOR DATA

(71) Applicants: Shahar SOREK, West Hollywood, CA (US); Albertino MATALON, Tel Aviv (IL)

(72) Inventors: Shahar SOREK, West Hollywood, CA (US); Albertino MATALON, Tel Aviv (IL)

(21) Appl. No.: 15/550,035

(22) PCT Filed: Jan. 19, 2016
(86) PCT No.: PCT/IL2016/050060

§ 371 Date: Aug. 10, 2017

Related U.S. Application Data
(60) Provisional application No. 62/114,098, filed on Feb. 10, 2015.

(51) Int. Cl. A63F 13/69; A63F 13/822; A63F 13/79; G06N 99/00; A63F 13/67

(52) U.S. Cl. CPC A63F 13/69; G06N 99/005; A63F 13/67; A63F 13/79; A63F 13/822

(57) ABSTRACT

System and method for retaining a strategy video game player by classifying and predicting the player game satisfaction using data extracted from player interactive game sessions. The system and method are comprised of the following: (1) a strategy game player is classified to a predefined game personality archetype/s with specific psychological needs. (2) The satisfaction of player needs (or need satisfaction) is continually monitored (3) In cases where the satisfaction decreases, the system provides motivation in order to increase satisfaction.

### FIELD OF THE INVENTION

The present invention relates to strategy video games and, more particularly, to a system and method for retaining a strategy video game player.

### BACKGROUND OF THE INVENTION

Retaining and engaging strategy video game players in a strategy video game is a huge challenge as players increasingly demand high value for their time and money. Research and observations have shown that the term “value”, in this context, means the satisfying of psychological needs, as people who play strategy video game are typically people who are looking to escape the real world to a world of fantasy, looking to express their hidden and/or suppressed emotions, like to have or to hide under different glamour identities, etc. In other words, these people are looking to satisfy their real-life psychological deprivations and as long as these people will be provided with their psychological needs they will continue to play the game and be satisfied.

### SUMMARY OF THE INVENTION

According to the present invention there is provided A method for improving retention of video game players, the method including (comprising in claim-delete): assigning a personality archetype to a player game personality in a personality classification process; mapping a psychological need to the a personality archetype, the psychological need is defined by a Game Designer; mapping a collection of game actions to the psychological need, the game actions being deemed relevant to increasing a satisfaction level of the psychological need; mapping motivators to the psychological need, the motivators include game bonuses available to be awarded to the player game personality in order to further increase the satisfaction level related to the psychological need when the satisfaction level is below a predetermined satisfaction threshold.

According to another embodiment there is provided A system for improving retention of video game players, the system including: a Game Platform including: a Game Server a Game database; a Game Admin user; and a User Retention Array, the User Retention Array including: a Player Intervention Processor, a Players Data Collector, a Satisfaction Processor, a Player Classifier, a Models Factory, a Players Satisfaction Manager user interface (UI), a Motivators to Need Mapper UI and an Admin user; wherein the Player Classifier receives Player Data Objects from the Players Data Collector and Personality Archetype models from the Model Factory, and accordingly classifies and creates a Player Game personality for each Player; a Game Action to Need Mapper user interface (UI) that allows the Admin user to map Game Actions to Psychological Needs, the psychological needs are defined by a Game Designer; the Motivators to Need Mapper UI that allows the Admin user to map Motivators to the Psychological Needs; the Players Data Collector, collects and aggregates the Game Actions, that are received from the Game Server and Game Clients, according to instructions from the Game Actions to Need Mapper and the Player Classifier, wherein the Game Clients are in electronic data communication with the Players Data Collector over a computing network; the Satisfaction Processor predicts a player satisfaction level for a specific psychological need according to Player Data Objects received from the Players Data Collector and player satisfaction models received from the Models Factory; the Player Intervention Processor receives a Satisfaction Predictor for a specific the psychological need that corresponds to a unique the Player, a selected the Player Game Personality for the unique Player, at least one Motivators Object which is mapped to the specific psychological need, such that the Player Intervention Processor selects and activates a selected the Motivator, from the motivators object, which is calculated to satisfy the specific psychological need of the unique Player having a specific the satisfaction level below a predefined satisfaction threshold; the Player Satisfaction Manager UI allows the Admin user to view information regarding the satisfaction level of the psychological need of the Players, based on information collected from the Satisfaction Processor; and the Model Factory generates prediction models for each of the satisfaction levels for each of the psychological needs, and classification models for Personality Archetypes, according to information received from the Game Action to Need Mapper UI and the Player Data Objects received from Players Data Collector.

According to further features in preferred embodiments of the invention described below the Players Data Collector, comprises: a collection of the Player Data Objects for each Player, the Player Data Objects including: Player Actions for Need Object, the Player Actions for Need Object designed to collect and hold only the Game Actions pre mapped to a specific the psychological Need according to the Game Action to Need Mapper, the Game Actions being generated during a game session or between game sessions, a Player Direct Action Data Object, the Player Direct Action Data Object designed to collect and hold only the Game Actions related to the unique Player response to direct questions or requests for selection presented to the unique Player by the Admin user, a Historical Action Data Object, the Historical Action Data Object designed to collect and hold only all the Game Actions for the unique Player.

According to still further features in the described preferred embodiments further including: a Data Objects Creator, the Data Objects Creator adapted to: create the Player Data Objects for each the unique Player, create, for each the psychological Need, the Player Actions for Need Objects, within each of the Player Data Objects, create the Player Direct Action Data Object within each the Player Data Objects, and create the Player Historical Action Data Object, within each the Player Data Objects.

According to still further features further including: a Data Receiver, the Data Receiver receives the Game Actions from the Game Server and the Game Clients and distributes the Game Actions to corresponding the Player Data Objects.

According to still further features further including: a Data Push Controller, the Data Push Controller submits unique the Player Data Objects to the Player Classifier, the Satisfaction Processor and the Models Factory upon start of game session or end of game session for the unique Player, wherein, upon submission, the Data Push Controller clears all the Game Actions collected in the Player Actions for Need Objects.

According to still further features wherein the Data Push Controller uses a unique the Player Personality from the Player Classifier in order to submit only relevant the Player Action for Need Data Objects for the unique Player.

According to still further features wherein the Player Classifier includes: a Direct Classification (Classifier) Models Bank, the Direct Classification Models Bank receives and holds Direct Models for direct personality archetype classifications from the Models Factory, a Direct Player Classifier, the Direct Player Classifier receives the Player Direct Actions Data Object for each the unique Player, from the Players Data Collector and the Direct Models for the direct personality archetype classifications from the Direct Classification Models Bank and using a machine learning classification process to detect/determine a respective the Personality archetype for each the unique Player, a Historical Classification (“Overtime Classifier model bank”) Models Bank, the Historical Classification Models Bank receives and holds Historical Models for Historical personality archetype classifications from the Models Factory, wherein the Direct Player Classifier receives the unique Player Historical Actions Data Object for each the unique Player from the Players Data Collector and the Historical Models for the Historical personality archetype classifications from the Historical Classification Models Bank and uses the machine learning classification process to, detect/determine/decide the Personality archetype for each the unique Player, and a Classifier Result Accumulator, the Classifier Result Accumulator receives classification results from the Direct Player Classifier, the Historical Player Classifier and uses an algorithm to perform classifications and detection of the Personality archetype for each the unique Player.

According to still further features wherein the Satisfaction Processor includes: a plurality of Needs Satisfaction Processors, each of the Needs Satisfaction Processors designed to predict the satisfaction level for a specific the psychological Need according to the unique Player, the Player Action for Need Data Object and a Satisfaction Prediction model from the Models Factory.

According to still further features wherein each of the plurality of Needs Satisfaction Processors is related to a specific the psychological need and includes: a Satisfaction Classifier which receives, for the specific psychological need from Model Factory, relevant to the unique Player: a specific the Satisfaction Prediction model, and a specific the Player Action Data Object, and uses a machine learning process to generate the Satisfaction predictor for the specific psychological need which is adjusted by a Threshold processor.

According to still further features wherein the Player Intervention Processor includes: a plurality of Needs Intervention Processors, each of the Needs Intervention Processors designed to select a corresponding the Motivator for a specific the psychological need for the unique Player in a state wherein the Satisfaction Predictor for the specific psychological Need indicates that the satisfaction level will be below the predefined satisfaction threshold.

According to still further features, wherein the Player Intervention Processor includes: a Motivator Selector for the specific psychological Need, the Motivator Selector receives the Satisfaction Predictor for the specific psychological need that corresponds to the unique Player, the Motivators Object which includes corresponding the Motivators for the specific psychological Need and uses a selection algorithm to select a best the Motivator having a highest likelihood to raise the satisfaction level of the unique Player that is below the satisfaction threshold.

According to still further features wherein the Models Factory generates Direct Models, Historical Models and Satisfaction Prediction models for each of the psychological Needs using machine learning classification and prediction algorithms, the machine learning classification and prediction algorithms use training data generated by a Test Player that uses a Test Game Client.

According to still further features wherein the Training data includes: the Game Actions generated by the Test Player, and direct specific information provided by the Test Player by answering specific questions that are presented to the Test Player by the Test Game Client (130) at a specific time during a game session; wherein the questions are designed to determine: the satisfaction level of the Test Player for each of the psychological needs, and personality preferences for the Test Player so as to label the Player Data Objects for the Test Player.

According to still further features wherein the Models Factory includes: Classification model builders for the Personality Archetypes, the Classification model builders adapted to generate the Direct Models and the Historical Models using machine learning model building based on Player Direct Actions data objects and Player Historical Actions data objects.

According to still further features wherein the Models Factory includes: a Personality Archetype Models storage, which stores generated Personality classification models; a Prediction model builder for Needs, which generates Satisfaction Prediction models for the psychological Needs using machine learning model building based on Player Actions for Need Data Objects and satisfactions labels determined from the Test Player answers; and a Need Satisfaction Prediction Models storage, which stores the Satisfaction Prediction Models.

### BRIEF DESCRIPTION OF THE DRAWINGS

Various embodiments are herein described, by way of example only, with reference to the accompanying drawings, wherein:

FIG. 1 is a high level schematic description of the invention concept;

FIG. 2 is a high level block diagram of a typical Strategy Video Game Platform (block 192) and the Present Invention;

FIG. 3 is a high level block diagram of the internal structure and data flow of block 170, Players Data Collector;

FIG. 4 is a high level block diagram of the internal structure and data follows of block 180, Players Classifier;

FIG. 5 is a high level block diagram of the internal structure and data flow of block 175, Players Satisfaction Processor;

FIG. 6 is a high level block diagram of the internal structure and data flow of block 400, Need 1 Satisfaction Processor;

FIG. 7 is a high level block diagram of the internal structure and data flow of block 165, Player Intervention Processor;

FIG. 8 is a high level block diagram of the internal structure and data flow of block 600, Player Intervention Processor;

FIG. 9 is a high level block diagram of the internal structure and data flow of block 177, Models Factory.

### DESCRIPTION OF THE PREFERRED EMBODIMENTS

### Strategy Video Game Player Archetypes

Like in the real world, strategy video games provide a world (in this case virtual world), where real people are able to: virtually live and gain life experience, collect or buy assets, build homes/cities, evolve according to their skills, cultivate social relationships and interact with other people, be a part of an economy (using real world money), etc. In many ways people who play strategy video games see the virtual world as their “fantasy second life” and adopt corresponding game personalities. Typically, the player game personality is based on the player real-life personality with some “modifications”, as game personality may be intensified and include hidden and/or suppressed emotions and needs. These personality “modifications” occur due to the fact that in strategy video games the player is anonymous and therefore able to behave freely without any sense of personal shame or insecurity.

According to the invention, the game personality of a strategy video game player may be evolved and shaped into one or a combination of the following personality archetypes: (1) “The Builder”; (2) “The Social”; (3) “The Explorer”; (4) “The Warrior”; (5) “The Leader”. Each of these game personality archetypes has specific and mapped psychological needs.

Note: The definition and/or number of personality archetypes may be reduced or increased according to the specific design of the strategy video game and other considerations.

### The Definition of Needs Per Archetype

According to the invention, each personality archetype has a specific and mapped group of psychological needs, which are preferably determined and predefined by the strategy video game designer. For example:
(1) “The Builder”: (a) Create and build; (b) innovate; (c) have resource to create; (d) reach resources for building; (e) help other people to create; (f) get missing resources from other people; (g) “Left alone” but be around other players, etc.
(2) “The Social”: (a) Talk with other people; (b) be part of social group; (c) has a specific role in a social group; (d) receives appreciation for his/her role in the social group; (e) expands his/her social relations and interactions; (f) is approached by other people, etc.
(3) “The Explorer”: (a) finds things to do; (b) finds new places; (c) gets to known new people, etc.
(4) “The Warrior”: (a) target wars; (b) be a target of wars; (c) loses wars; (d) wins wars; (e) has the best and latest weapons; (f) has large amounts of Assets, etc.
(5) “The Leader”: (a) Lead a group people; (b) receives appreciation for his/her leadership; (c) expands the group by adding new people; (e) has large amount of Assets, etc.

According to this invention, personality archetypes may also share the same psychological needs, as a player game personality may be evolved and shaped to a combination of personality archetypes. Typically, in this case, one of the personality archetypes will be the dominant personality archetype, with the most important needs to satisfy, while the other game personality archetype/s will be complementary, with needs of lesser importance.

In addition, According to the invention, player game personality has two additional groups of needs: (1) game progression needs, which may include (but not limited to): (a) get to a higher level in the game over time (b) place at high rank in the game leader board, etc.; (2) game behavior needs, which may include (but not limited to): (a) game performance (b) game availability, etc.

Notes: (1) a psychological need is defined according to the specific design of the strategy video game and other considerations; (2) the number of psychological needs for a personality archetype may be reduced or increased according to the specific design of the strategy video game and other considerations.

### Satisfying Needs

According to the invention, a specific psychological need (of a player which is classified to a personality archetype) is satisfied when all or part of the following conditions are met: (1) the player actively performs an action or a set of actions, which are associated with the specific psychological need, and receives the relevant reactions in relevant timing; (2) The player passively receives interactions and/or is involved in action/s associated with this specific psychological need, which are performed by other player/s or machines (game bot or game environment), and receives relevant interactions in relevant timing; (3) the player feels that the game environment is fair and responsive, even if the player him or herself is not fair.

Per the above conditions and according to this invention, satisfying a psychological need directly relates to player active and passive game actions and interactions, and therefore each psychological need is associated with a group of predefined and mapped passive and active game actions. The term game action means, action which is directly generated by the game or processed by the game.

For example, (1) the action group for the psychological need “Create and build”, which (in the above example) is associated with “The Builder” personality archetype, may be mapped and include (but not limited to) the following game actions: (a) Build actions; (b) Spend at least 50% of the game session time in building actions; (c) Re-modify building, etc. (2) the action group for the psychological need “be a target of wars”, which (in the above example) associated to “The Warrior” personality archetype, may be mapped and include (but not limited to) the following game actions: (a) Attacked by another Player; (b) Be a subject of espionage; (c) Lose assets after war, etc.

Notes: (1) The above satisfaction conditions are provided as an example and may be changed according to the specific design of the strategy video game and other considerations; (2) the above selection, association and mapping of game actions to psychological need are provided as an example and may be changed according to the specific design of the strategy video game and other considerations.

### DESCRIPTION OF THE DRAWINGS

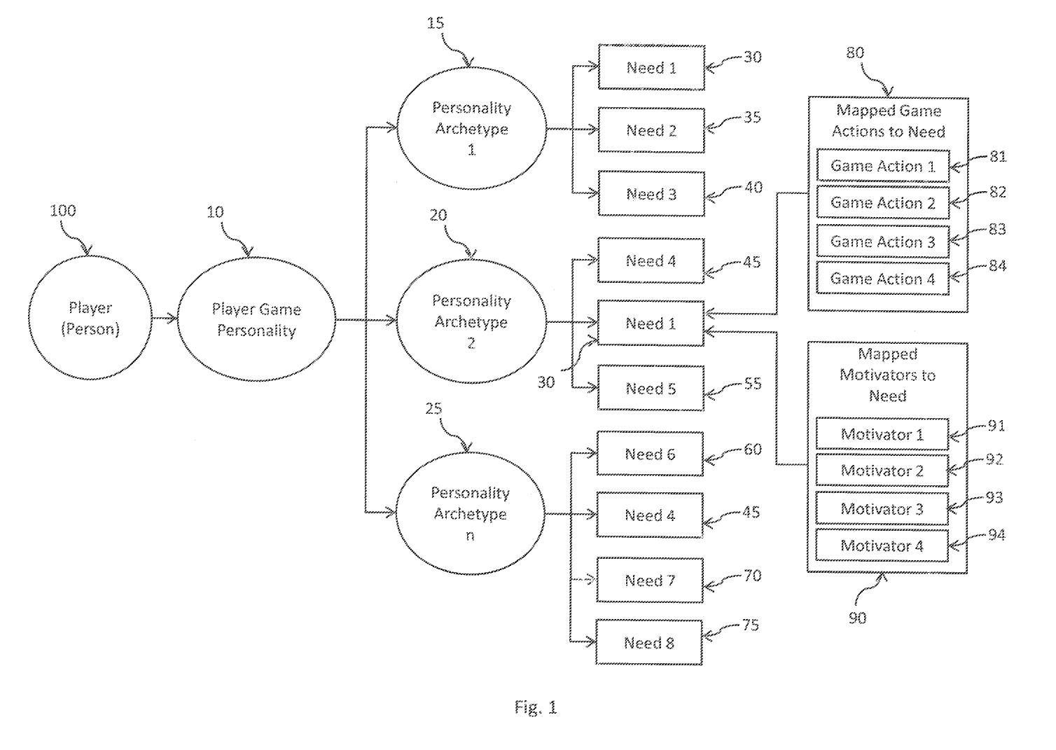

FIG. 1 shows a high level schematic description of the invention concept.

Block 100 represents a Player, who plays a strategy video game and has a Player Game Personality (10). Blocks 15, 20, 25 represent Personality Archetypes, which may be assigned to a Player Game Personality (10) following a manual or automatic personality classification process. Blocks 30, 35, 40, 45, 55, 60, 65, 70 and 75 represents psychological need for Personality Archetype or AKA: Need, which may be mapped to Personality Archetype (15, 20 and 25) by a strategy video game designer. According to the invention, a strategy video game designer may map a Need (30, 35, 40, 45, 55, 60, 65, 70 and 75) to Personality Archetype (15, 20 and/or 25), only if the specific Need, according to the best judgment of the strategy video game designer, is relevant to the Personality Archetype psychological profile. For example: relevant Needs for Personality Archetype “The Warrior” may be: (a) targets wars; (b) a target of wars.

Blocks 81, 82, 83 and 84 represent Game Actions, which are Label Names of physical game actions that may be performed in a strategy video game, by Player/s or auto generated by the strategy video game, as were designed by the strategy video game designer. Block 80 represents Game Actions Object, which is a collection of Game Actions (81, 82, 83 and 84) that were mapped to a Need (30, 35, 40, 45, 55, 60, 65, 70 and 75), by a strategy video game designer. According to this invention, a strategy video game designer may map a specific Game Action (81, 82, 83 and 84) to a specific Need (30, 35, 40, 45, 55, 60, 65, 70 and 75), only if the specific Game Action is, according to the best Judgment of the strategy video game designer, relevant to the satisfaction of the psychological Need. For example: if the Personality Archetype is: “The Warrior” and the Need is: “Be a target of wars”, then a relevant Game Action may be: “Attacked by Player X”. Blocks 91, 92, 93 and 94 represent Motivators, which are game bonuses that may be given to a Player/s in order to increase the satisfaction of specific need(s) of Player(s), as was designed by the strategy video game designer. Block 90 represents Motivators (motivational) Object, which is a collection of Motivators (91, 92, 93 and 94) that were mapped to a Need (30, 35, 40, 45, 55, 60, 65, 70 and 75), by a strategy video game designer.

According to the invention, a strategy video game designer may map a specific Motivator (91, 92, 93 and 94) to a specific Need (30, 35, 40, 45, 55, 60, 65, 70 and 75), only if the specific Motivator is, according to the best Judgment of the strategy video game designer, will increase the Player game satisfaction when a specific Need is not satisfied. For example: if a Player-A has a Personality Archetype: “The Warrior” and the Need “Be a target of wars” is not satisfied, then a relevant Motivator may be: “Be attacked by Player Z” (Player Z may be an AI “system player”).

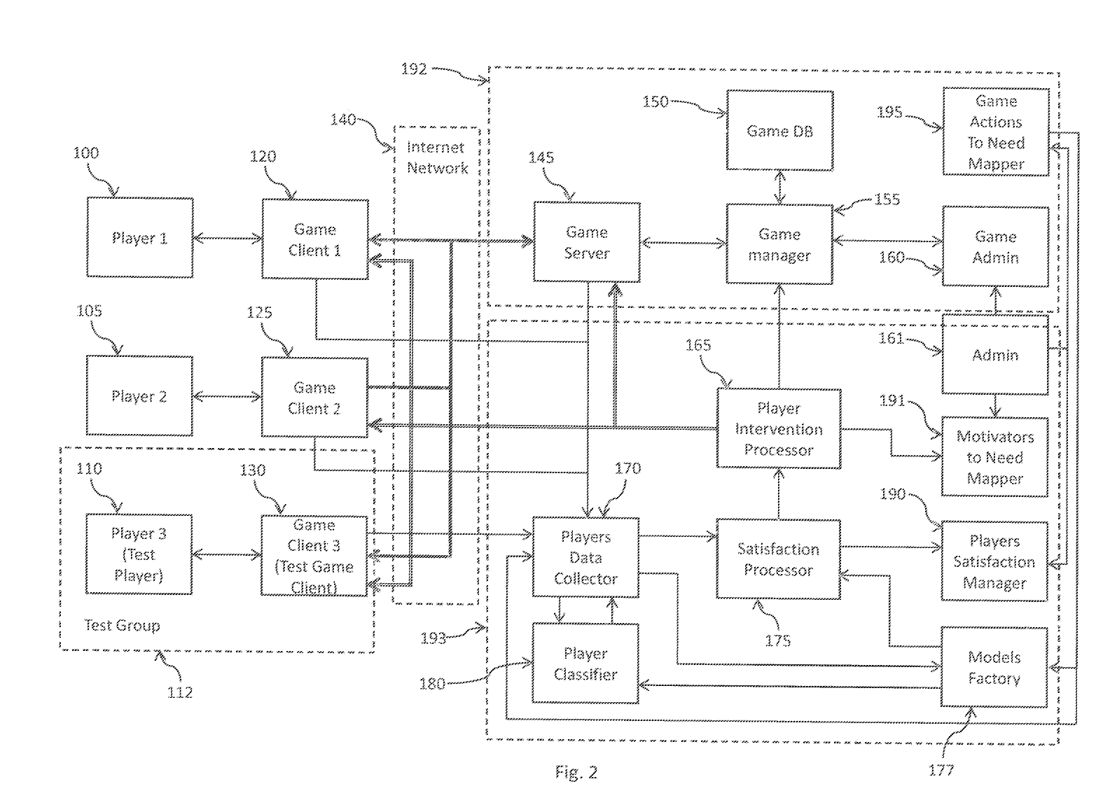

FIG. 2 shows a high level block diagram of a typical Strategy Video Game Platform (block 192) and the Present Invention (block 193).

Block 100, 105 and 110 represent strategy video game Players, who may be Internet users that play a strategy video game, using a strategy video Game Client (120, 125 and 130), which may be implemented as: a desktop application, a mobile application, a web application, etc. and include a fully functional strategy video game according to the strategy video game designer. Each Player (100, 105 and 110) has a unique ID identifier, which is used to uniquely identify the Player.

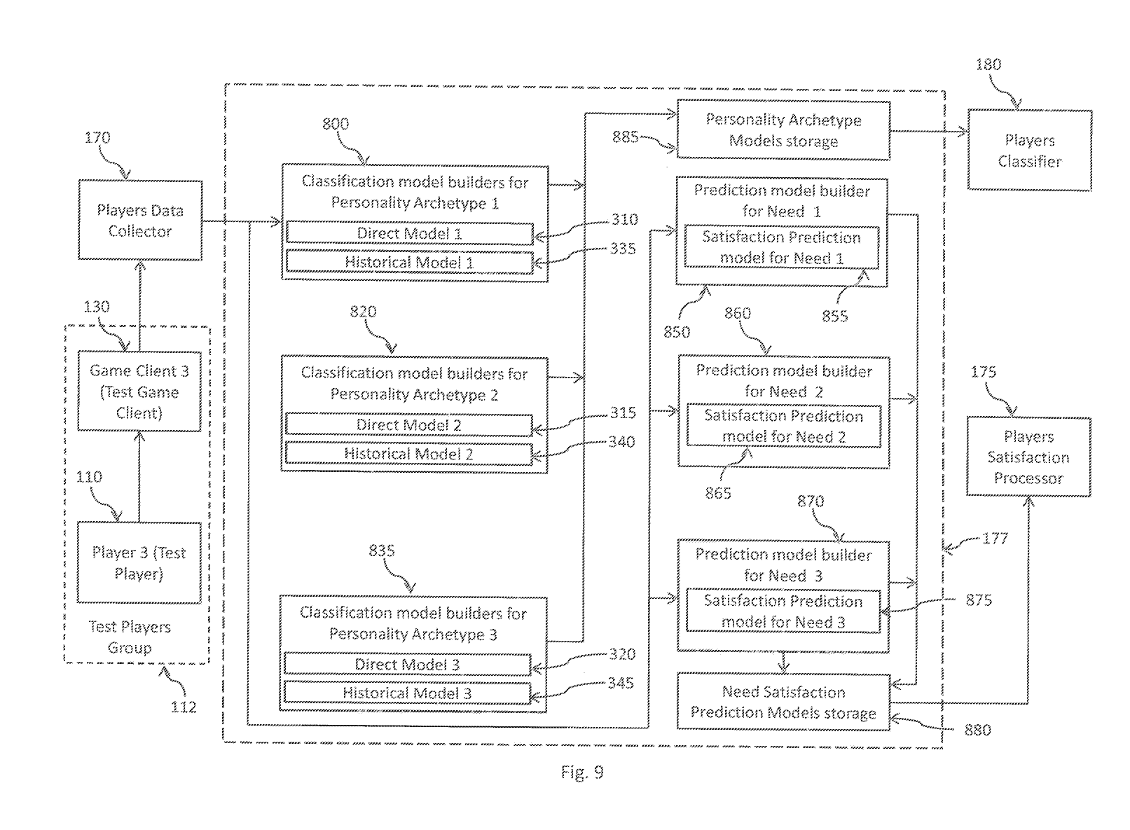

Block 112 represents a Test Group, which includes Test Players (e.g. 110) who use Test Game Clients (e.g. 130) with special features. The functionality of Block 112 will be described in more detail with reference to FIG. 9.

Block 140 represents the Internet Network, which serves as a connection between Game Clients (120, 125 and 130) and Game Server (145), Player Intervention Processor (165) and Players Data Collector (170). Block 145 represents a Game Server, which provides game information to Game Clients (120, 125 and 130) according to Game Manager (155). Block 155 represents Game Manager, which contains all game setting and game definitions for each player according to the Strategy Video Game Platform (192) gameplay design. Block 150 represents a Game database (DB), which is a repository for game definitions as was implemented and defined in Game Manager (155). Block 160 represents a Game Admin, which is an administrative control interface allowing an Admin (161), a person who may be the strategy video game designer, to create and update the game definitions.

Block 195 represents Game Action to Need Mapper, which is a user interface (UI) that allows an Admin (161) to map specific Game Action (81, 82, 83 and 84) to specific Need (30, 35, 40, 45, 55, 60, 70 and 75) as shown in FIG. 1. Block 191 represents Motivators to Need Mapper, which is a UI that allows an Admin (161) to map specific Motivator (91, 92, 93 and 94) to specific Need (30, 35, 40, 45, 55, 60, 70 and 75) as shown in FIG. 1. Block 170 represents Players Data Collector, which collects and aggregates Game Actions (81, 82, 83 and 84), that are received from Game Server (145) and Game Clients (120, 125 and 130), according to instructions from Game Actions to Need Mapper (195) and Player Classifier (180). Block 180 represents Player Classifier, which receives Player Data Objects from Players Data Collector (170) and Personality Archetype models from Model Factory (177), and accordingly classifies and creates Player Game personality (10) for each Player (100,105 and 110). Block 175 represents a Player Satisfaction Processor, which predicts a Player (100, 105 and 110) satisfaction for a specific Need (30, 35, 40, 45, 55, 60, 70 and 75) according to Player Data Objects from Players Data Collector (170) and player satisfaction model from Models Factory (177). Block 165 represents a Player Intervention Processor, which receives: Satisfaction Predictor for a specific Need (30, 35, 40, 45, 55, 60, 70 and 75) that corresponds to unique Player (100, 105 and 110), Player Game Personality (10) for the same unique Player (100, 105 and 110), Motivators Object (90) which is mapped to the specific Need (30, 35, 40, 45, 55, 60, 70 and 75) and accordingly select and activate the best Motivator to satisfy the unique Player's unsatisfied specific Need. Block 190 represents a Player Satisfaction Manager, which is a UI that allows the Admin (161) to view information regarding specific Players (100, 105 and 110) Need satisfactions, based on information collected from Satisfaction Processor (175). Block 177 represents Model Factory, which generates prediction models for Need (30, 35, 40, 45, 55, 60, 70 and 75) satisfaction, and classification models for Personality Archetype (15, 20 and 25), according to information from Game Action to Need Mapper (195) and Player Data Objects from Players Data Collector (170).

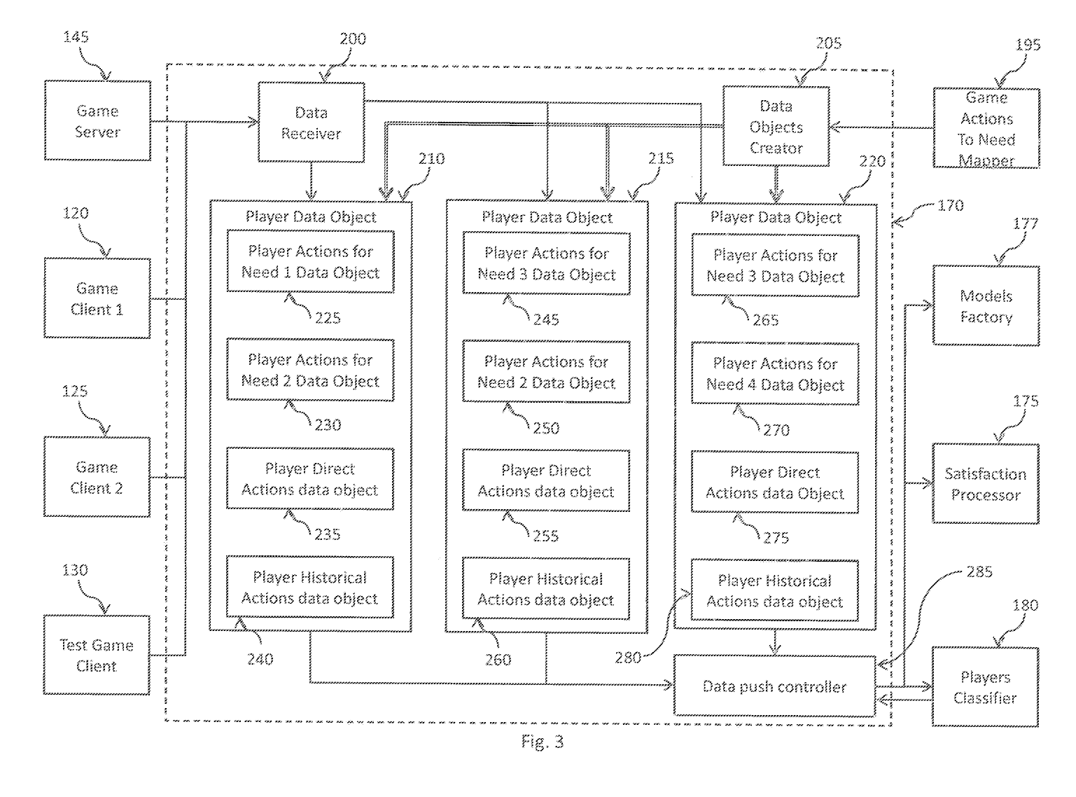

FIG. 3 shows a high level block diagram of the internal structure and data flow of block 170, Players Data Collector.

Block 210, 215 and 220 represent unique Player Data Objects, which holds a collection of other Player Data Objects for every unique Player (100, 105 and 110). Block 225, 230, 245, 250, 265 and 270 represents Player Actions for Need Object, which is designed to collect and hold only Game Actions (81, 82, 83 and 84) that were pre mapped to a specific Need according to Game Action to Need Mapper (195). Player Actions for Need Object (225, 230, 245, 250, 265 and 270) is designed to collect and hold Game Actions for a unique Player (100, 105 and 110), which were generated during a game session or between game sessions. Block 235, 225 and 275 represents Player Direct Action Data Object, which is designed to collect and hold only Game Actions (81, 82, 83 and 84) that are related to unique Player (100, 105 and 110) response to direct questions or requests for selection presented to the Player by the Admin (161). Block 240, 260 and 280 represent Historical Action Data Object, which is designed to collect and hold only all Game Actions (81, 82, 83 and 84) for unique Player (100, 105 and 110). Block 205 represents Data Objects Creator, which creates: (1) Player Data Objects (210, 215 and 220) for each unique Player (100, 105 and 110); (2) within each Player Data Objects (210, 215 and 220), creates, for each Need (30, 35, 40, 45, 55, 60, 70 and 75), Player Actions for Need Objects (225, 230, 245, 250, 265, 270); (3) within each Player Data Objects (210, 215 and 220), creates Player Direct Action Data Object (235, 225, 275); (4) within each Player Data Objects (210, 215 and 220), creates Player Historical Action Data Object (240, 260, 280). Block 200 represents Data Receiver, which receives Game Action (81, 82, 83 and 84) from Game Server (145), Game Client 1 (120)), Game Client 2 (125)), Game Client 3 (130) and distributes them to corresponding Player Objects. Block 285 represents Data Push Controller, which submits unique Player Data Objects to Player Classifier (180), Satisfaction Processor (175) and Models Factory (177) upon unique Player (100, 105 and 110) start of game session or end of game session. Upon submission, Data Push Controller (285) clears all Game Actions which are collected in Player Actions for Need Objects.

Data Push Controller (285) uses unique Player Personality (360, 365 and 370) from Player Classifier (190) in order to submit only the relevant Player Action for Need Data Object (225, 230, 245, 250, 265 and 270) for the unique Player (100, 105 and 110).

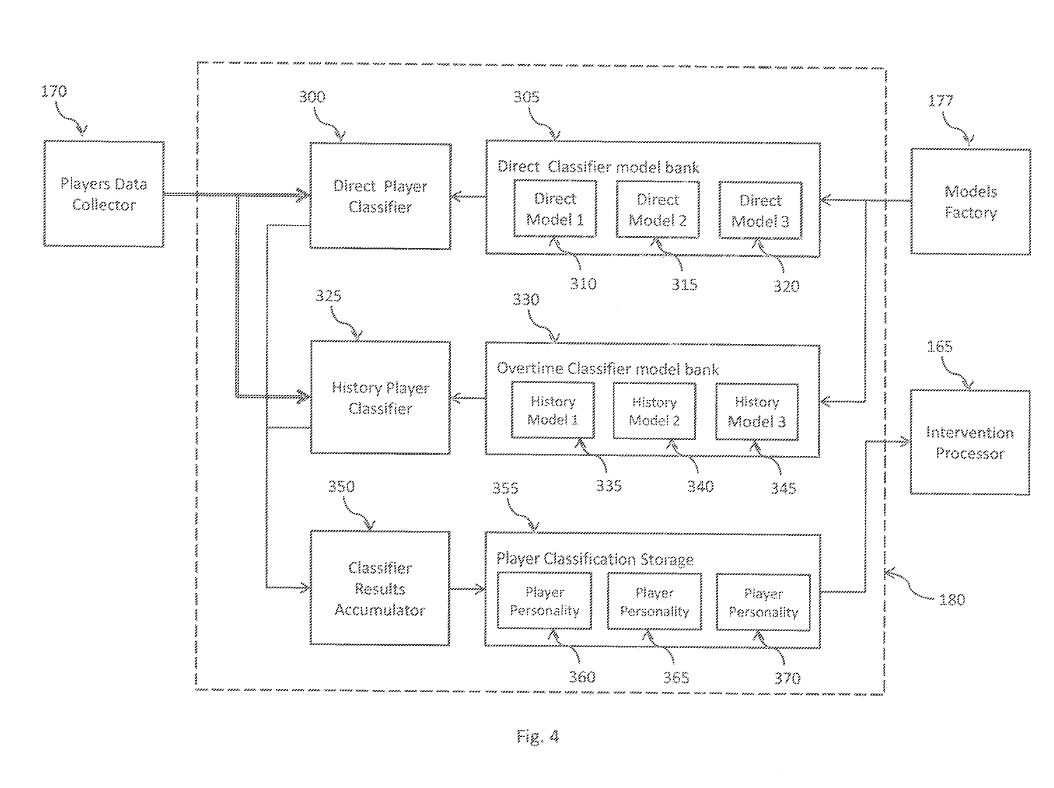

FIG. 4 shows a high level block diagram of the internal structure and data follows of block 180, Players Classifier.

Block 305 represents a Direct Classification (Classifier) Models Bank, which receives and holds Direct Models (310, 315 and 320) for direct personality archetype classifications from Models Factory (177). Block 300 represents a Direct Player Classifier, which receives Player Direct Actions Data Object (235, 255, and 275) for a unique Player (100, 105 and 110), from Players Data Collector (170) and Direct Models (310, 315 and 320) for direct personality archetype classifications from Direct Classification Models Bank (305) and using a machine learning classification process as known in the art, detect/determine the unique Player (100, 105 and 110) Personality archetype (15, 20 and 25).

Block 330 represents Historical Classification Models Bank (“Overtime Classifier model bank”), which receives and holds Historical Models (335, 340 and 345) for Historical personality archetype classifications from Models Factory (177). Block 300 represents Direct Player Classifier, which receives Player Historical Actions Data Object (240, 260, and 280) for a unique Player (100, 105 and 110), from Players Data Collector (170) and Historical Models (335, 340 and 345) for Historical personality archetype classifications from Historical Classification Models Bank (330) and using a machine learning classification process as known in the art, detect the unique Player (100, 105 and 110) Personality archetype (15, 20 and 25).

Block 350 represents a Classifier Result Accumulator, which receives classification results from Direct Player Classifier (300), Historical Player Classifier (325) and, using an algorithm, performs accurate classifications and detection/determination of the unique Player (100, 105 and 110) Personality archetype (15, 20 and 25). The detected Personality archetype (15, 20 and 25) for the unique Player (100, 105 and 110) is stored in unique Player Personality (360, 365 and 370) located in Players Classification storage (355). Player Personality (360, 365 and 370) is submitted to Player Intervention Processor (165) on demand.

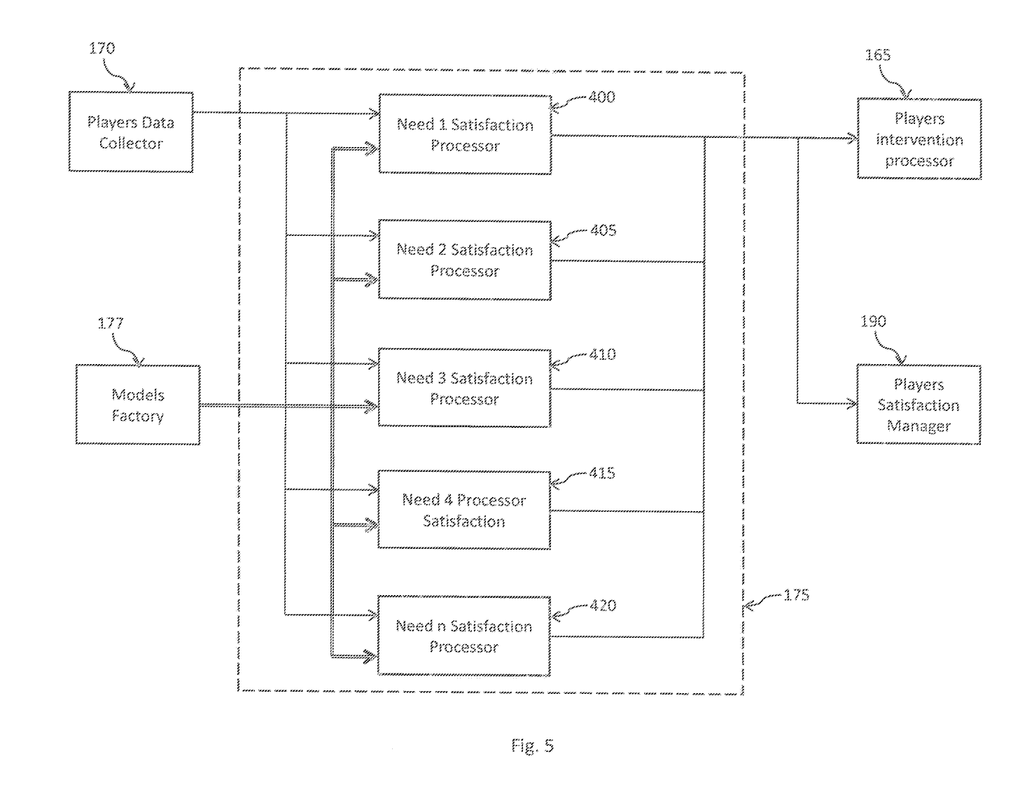

FIG. 5 shows a high level block diagram of the internal structure and data flow of block 175, (Players) Satisfaction Processor.

Blocks 400, 405, 410, 415 and 420 represent Needs Satisfaction Processors, which are designed to predict Player (100, 105 and 110) satisfaction for Need (30, 35, 40, 45, 55, 60, 65, 70 and 75) according to unique Player (100, 105 and 110) Player Action for Need Data Object (225, 230, 245, 250, 265 and 270) and Satisfaction Prediction model for Needs (855, 865 and 875) from Models Factory (177) (see FIG. 9). Players Satisfaction Processor (175) may include any number of Need Satisfaction Processors (400, 405, 410, 415 and 420) according to the definition of the Strategy Video Game designer.

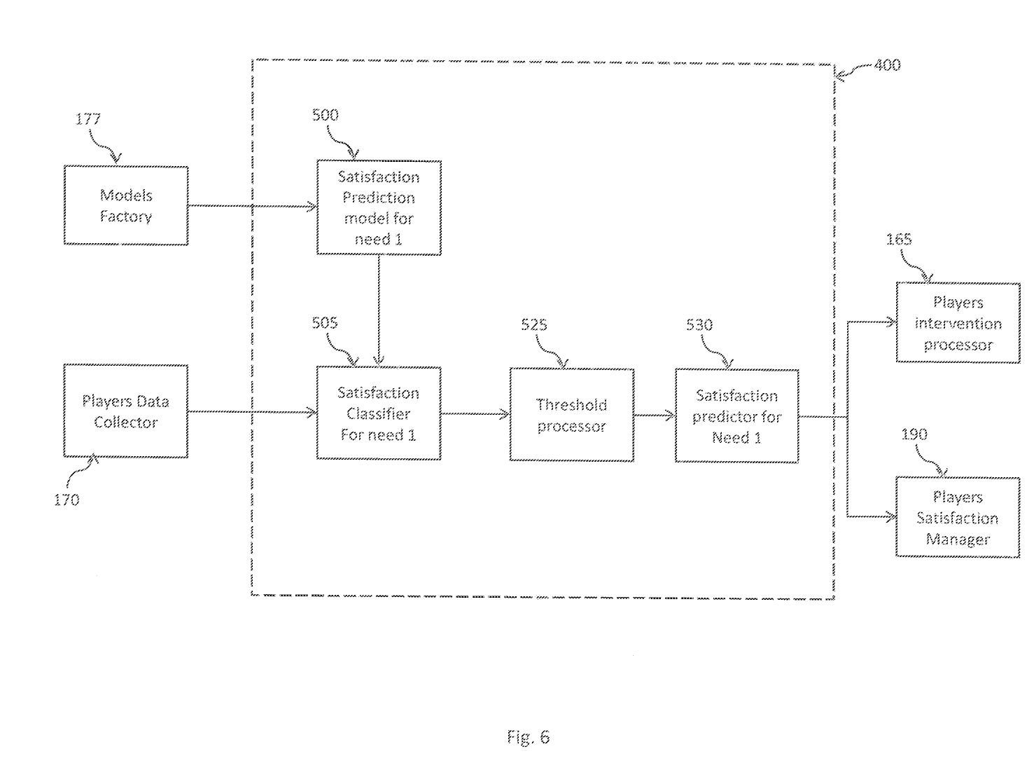

FIG. 6 shows a high level block diagram of the internal structure and data flow of block 400, Need 1 Satisfaction Processor. Blocks 405, 410, 415 and 420 have similar structure and data flow to block 400.

Block 505 represents a Satisfaction Classifier For need 1, which receives Satisfaction Prediction model for need 1 (500) from Model Factory (177) and unique Player (100, 105 and 110) Player Action for Need 1 Data Object (225) from Players Data Collector (170) and using machine learning process as known is the art, generates Satisfaction predictor for Need 1 (530) which is adjusted by Threshold processor (525).

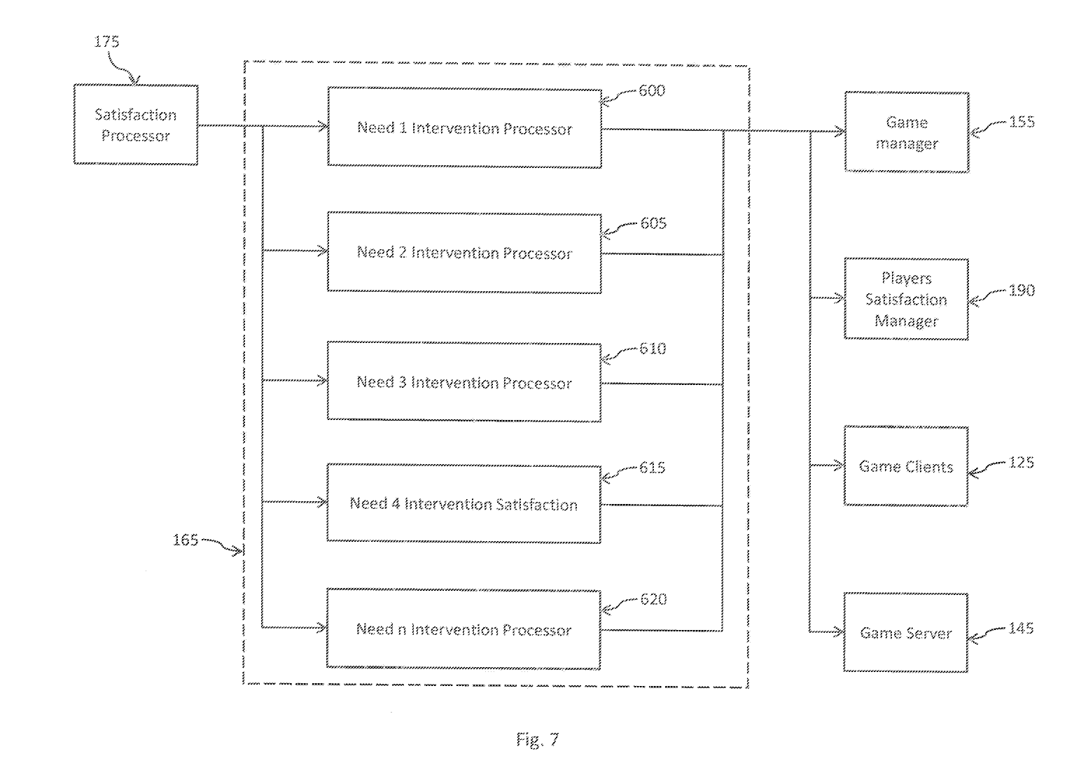

FIG. 7 shows a high level block diagram of the internal structure and data flow of block 165, Player Intervention Processor.

Blocks 600, 605, 610, 615 and 620 represent Needs Intervention Processors, which are designed to select corresponding Motivator (91, 92, 93 and 94) for Player (100, 105 and 110) specific Need (30, 35, 40, 45, 55, 60, 65, 70 and 75) in case the Satisfaction Predictor for Need (e.g. 530) for this specific Need shows low satisfaction level.

Player Intervention Processor (165) may include any number of Player Intervention Processors (600, 605, 610, 615 and 620) according to the definition of the Strategy Video Game designer.

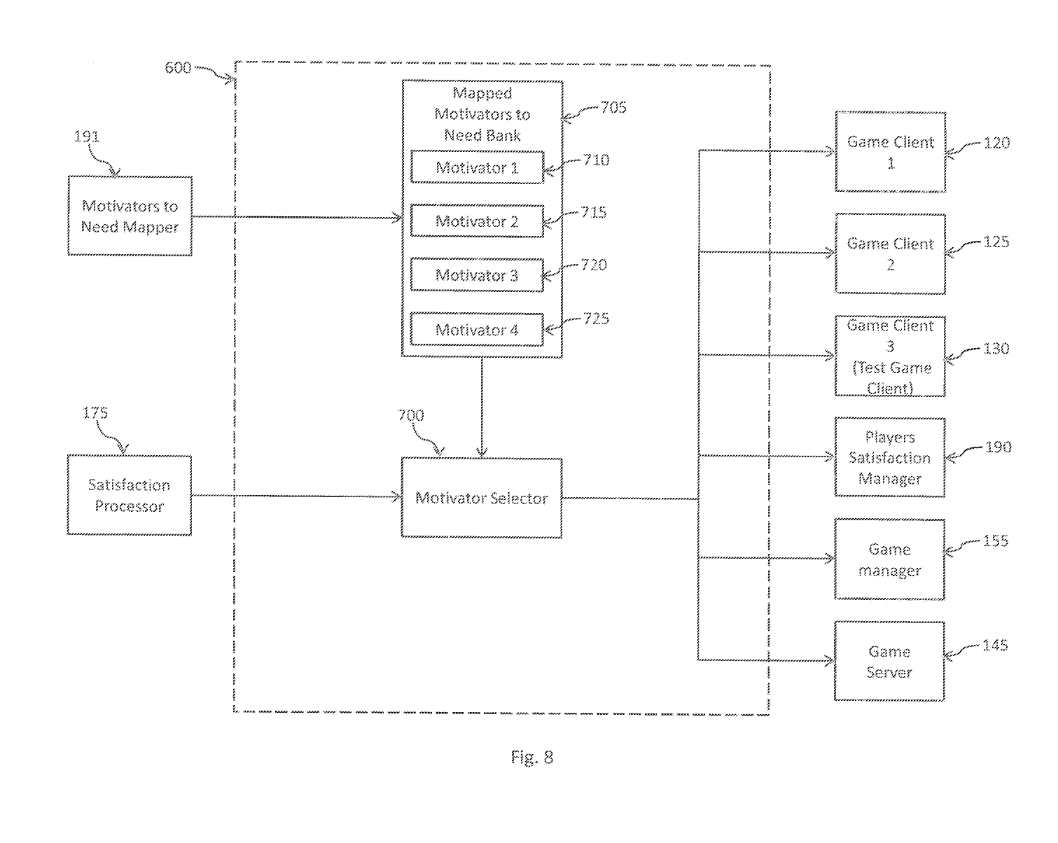

FIG. 8 shows a high level block diagram of the internal structure and data flow of block 600, Player Intervention Processor. Blocks 605, 610, 615 and 620 have similar structure and data flow to block 600.

Block 700 represents Motivator Selector for specific Need (30, 35, 40, 45, 55, 60, 65, 70 and 75), which receives Satisfaction Predictor for Need 1 (530) for unique Player (100, 105 and 110), Motivators Object (90) which include corresponding Motivators (91, 92, 93 and 94) for specific Need and using selection algorithm select the best Motivator with the higher chance to increase the Player (100, 105 and 110) dissatisfy Need (i.e. using a selection algorithm to select a best said Motivator having a highest likelihood to raise satisfaction level of said unique Player that is below said satisfaction threshold). The selected Motivator is then submitted to corresponding Player directly or through Game Manager (155) and/or Game Server (145).

FIG. 9 shows a high level block diagram of the internal structure and data flow of block 177, Models Factory.

Models Factory (177) generates Direct Models (310, 315 and 320), Historical Models (335, 340 and 345) and Satisfaction Prediction models for Need (855, 865 and 875) using machine learning classification and prediction algorithms, which use training data (as known in the art) that are generated by Test Player (110) who uses Test Game Client (130). Block 112 (FIG. 2) represents Test Players Group, which may include any number of Test Players (110) who collectively generate training data for Models Factory (177). Training data are Game Actions (81, 82, 83 and 84), which are generated by a Test Player (110) or associated to a Test Player (110) and direct specific information, which the Test Player (110) provides by answering specific questions that are presented to the Player (110) by Test Game Client (130) at a specific time during the game session. The target of the questions and answers are to get the Test Player's (110) real sense of needs satisfaction, Player personality preferences and accordingly labels the Test Player (110) Data Objects. For example: following a game session a Test Player (110), who was associated with the personality archetype “The Warrior”, may be asked if his need to “target wars” was satisfied? If the Player answer “Yes”, then the Game Actions (81, 82, 83 and 84), which were mapped to this Need will have the “Yes” label in the Player corresponding to Player Actions for Need Data Object, within Player Data Object located in Players Data Collector (170).

Other information, which may be provided by the Player, may be collected and stored in Player Direct Actions data object, which may be used to classify the Player Game Personality (10). Blocks 800, 820 and 835 represent Classification model builders for Personality Archetypes, which generate Direct Models (310, 315 and 320) and Historical Models (335, 340 and 345) using machine learning model building as known in the art and according to Player Direct Actions data objects (235, 255 and 275) and Player Historical Actions data objects (240, 260 and 280). Block 885 represents Personality Archetype Models storage, which stores the generated Personality classification models. Block 850, 860 and 870 represent Prediction model builder for Needs, which generate Satisfaction Prediction model for Needs (855, 865 and 875) using machine learning model building as known in the art and according to Player Actions for Need Data Objects (225, 230, 245, 250, 265 and 270) and satisfactions labels resulted from Player (110) questions and answers as described above. Block 880 represents Need Satisfaction Prediction Models storage, which stores the generated Need Satisfaction Prediction Models.

What is claimed is:

1. A method for improving retention of video game players,
the method comprising: assigning a personality archetype to a player game personality in a personality classification process; mapping a psychological need to said personality archetype, said psychological need is defined by a Game Designer; mapping a collection of game actions to said psychological need, said game actions being deemed relevant to increasing a satisfaction level of said psychological need; mapping motivators to said psychological need, said motivators include game bonuses available to be awarded to said player game personality in order to further increase said satisfaction level related to said psychological need when said satisfaction level is below a predetermined satisfaction threshold.

2. A system for improving retention of video game players, the system comprising:
a Game Platform comprising: a Game Server a Game database; a Game Admin user;
and a User Retention Array, said User Retention Array comprising: a Player Intervention Processor, a Players Data Collector, a Satisfaction Processor, a Player Classifier, a Models Factory, a Players Satisfaction Manager user interface (UI), a Motivators to Need Mapper UI and an Admin user; wherein said Player Classifier receives Player Data Objects from said Players Data Collector and Personality Archetype models from said Model Factory, and accordingly classifies and creates a Player Game personality for each Player; a Game Action to Need Mapper user interface (UI) that allows said Admin user to map Game Actions to Psychological Needs, said psychological needs are defined by a Game Designer; said Motivators to Need Mapper UI that allows said Admin user to map Motivators to said Psychological Needs; said Players Data Collector, collects and aggregates said Game Actions, that are received from said Game Server and Game Clients, according to instructions from said Game Actions to Need Mapper and said Player Classifier, wherein said Game Clients are in electronic data communication with said Players Data Collector over a computing network; said Satisfaction Processor predicts a player satisfaction level for a specific psychological need according to Player Data Objects received from said Players Data Collector and player satisfaction models received from said Models Factory; said Player Intervention Processor receives a Satisfaction Predictor for a specific said psychological need that corresponds to a unique said Player, a selected said Player Game Personality for said unique Player, at least one Motivators Object which is mapped to said specific psychological need, such that said Player Intervention Processor selects and activates a selected said Motivator, from said motivators object, which is calculated to satisfy said specific psychological need of said unique Player having a specific said satisfaction level below a predefined satisfaction threshold; said Player Satisfaction Manager UI allows said Admin user to view information regarding said satisfaction level of said psychological need of said Players, based on information collected from said Satisfaction Processor, and said Model Factory generates prediction models for each of said satisfaction levels for each of said psychological needs, and classification models for Personality Archetypes, according to information received from said Game Action to Need Mapper UI and said Player Data Objects received from Players Data Collector.

3. The system of claim 2, wherein said Players Data Collector, comprises:
a collection of said Player Data Objects for each Player, said Player Data Objects including:
Player Actions for Need Object, said Player Actions for Need Object designed to collect and hold only said Game Actions pre mapped to a specific said psychological Need according to said Game Action to Need Mapper, said Game Actions being generated during a game session or between game sessions, a Player Direct Action Data Object, said Player Direct Action Data Object designed to collect and hold only said Game Actions related to said unique Player response to direct questions or requests for selection presented to said unique Player by said Admin user,
a Historical Action Data Object, said Historical Action Data Object designed to collect and hold only all said Game Actions for said unique Player.

4. The system of 3, further comprising: a Data Objects Creator, said Data Objects Creator adapted to: create said Player Data Objects for each said unique Player, create, for each said psychological Need, said Player Actions for Need Objects, within each of said Player Data Objects,
create said Player Direct Action Data Object within each said Player Data Objects, and create said Player Historical Action Data Object, within each said Player Data Objects.

5. The system of 3, further comprising: a Data Receiver, said Data Receiver receives said Game Actions from said Game Server and said Game Clients and distributes said Game Actions to corresponding said Player Data Objects.

6. The system of 3, further comprising: a Data Push Controller, said Data Push Controller submits unique said Player Data Objects to said Player Classifier, said Satisfaction Processor and said Models Factory upon start of game session or end of game session for said unique Player, wherein, upon submission, said Data Push Controller clears all said Game Actions collected in said Player Actions for Need Objects.

7. The system of 6, wherein said Data Push Controller uses a unique said Player Personality from said Player Classifier in order to submit only relevant said Player Action for Need Data Objects for said unique Player.

8. The system of 3, wherein said Player Classifier includes: a Direct Classification Models Bank, said Direct Classification Models Bank receives and holds Direct Models for direct personality archetype classifications from said Models Factory, a Direct Player Classifier, said Direct Player Classifier receives said Player Direct Actions Data Object for each said unique Player, from said Players Data Collector and said Direct Models for said direct personality archetype classifications from said Direct Classification Models Bank and using a machine learning classification process to detect a respective said Personality archetype for each said unique Player, a Historical Classification Models Bank, said Historical Classification Models Bank receives and holds Historical Models for Historical personality archetype classifications from said Models Factory, wherein said Direct Player Classifier receives said unique Player Historical Actions Data Object for each said unique Player from said Players Data Collector and said Historical Models for said Historical personality archetype classifications from said Historical Classification Models Bank and uses said machine learning classification process to, detect said Personality archetype for each said unique Player, and
a Classifier Result Accumulator, said Classifier Result Accumulator receives classification results from said Direct Player Classifier, said Historical Player Classifier and uses an algorithm to perform classifications and detection of said Personality archetype for each said unique Player.

9. The system of claim 2, wherein said Satisfaction Processor includes: a plurality of Needs Satisfaction Processors, each of said Needs Satisfaction Processors designed to predict said satisfaction level for a specific said psychological Need according to said unique Player, said Player Action for Need Data Object and a Satisfaction Prediction model from said Models Factory.

10. The system of claim 9, wherein each of said plurality of Needs Satisfaction Processors is related to a specific said psychological need and includes: a Satisfaction Classifier which receives, for said specific psychological need from Model Factory, relevant to said unique Player:
a specific said Satisfaction Prediction model, and a specific said Player Action Data Object, and uses a machine learning process to generate said Satisfaction predictor for said specific psychological need which is adjusted by a Threshold processor.

11. The system of claim 2, wherein said Player Intervention Processor includes: a plurality of Needs Intervention Processors, each of said Needs Intervention Processors designed to select a corresponding said Motivator for a specific said psychological need for said unique Player in a state wherein said Satisfaction Predictor for said specific psychological Need indicates that said satisfaction level will be below said predefined satisfaction threshold.

12. The system of claim 11, wherein said Player Intervention Processor includes: a Motivator Selector for said specific psychological Need, said Motivator Selector receives said Satisfaction Predictor for said specific psychological need that corresponds to said unique Player, said Motivators Object which includes corresponding said Motivators for said specific psychological Need and uses a selection algorithm to select a best said Motivator having a highest likelihood to raise said satisfaction level of said unique Player that is below said satisfaction threshold.

13. The system of claim 2, wherein said Models Factory generates Direct Models, Historical Models and Satisfaction Prediction models for each of said psychological Needs using machine learning classification and prediction algorithms, said machine learning classification and prediction algorithms use training data generated by a Test Player that uses a Test Game Client.

14. The system of claim 13, wherein said Training data includes: said Game Actions generated by said Test Player, and direct specific information provided by said Test Player by answering specific questions that are presented to said Test Player by said Test Game Client at a specific time during a game session; wherein said questions are designed to determine: said satisfaction level of said Test Player for each of said psychological needs, and personality preferences for said Test Player so as to label said Player Data Objects for said Test Player.

15. The system of claim 13, wherein said Models Factory includes:
Classification model builders for said Personality Archetypes, said Classification model builders adapted to generate said Direct Models and said Historical Models using machine learning model building based on Player Direct Actions data objects and Player Historical Actions data objects.

16. The system of claim 14, wherein said Models Factory includes: a Personality Archetype Models storage, which stores generated Personality classification models;
a Prediction model builder for Needs, which generates Satisfaction Prediction models for said psychological Needs using machine learning model building based on Player Actions for Need Data Objects and satisfactions labels determined from said Test Player answers; and
a Need Satisfaction Prediction Models storage, which stores said Satisfaction Prediction Models.
